(19) United States
(12) Patent Application Publication
(10) Pub. No.: US 2015/0170591 A1
(43) Pub. Date: Jun. 18, 2015

(54) FPR Liquid Crystal Display Panel and Liquid Crystal Display Device for 3D display

(71) Applicant: SHENZHEN CHINA STAR OPTOELECTRONICS TECHNOLOGY CO. LTD., Shenzhen (CN)

(72) Inventors: Hua Zhang, Shenzhen (CN); XueLiang Yang, Shenzhen (CN)

(21) Appl. No.: 14/235,805

(22) PCT Filed: Dec. 30, 2013
(86) PCT No.: PCT/CN2013/090829

§ 371 Date: Jan. 29, 2014

(30) Foreign Application Priority Data
Dec. 17, 2013 (CN) 201310694594.6

(51) Int. Cl. G09G 3/36

(52) U.S. Cl. CPC G09G 3/3648; G09G 2320/0209; G09G 2310/0251; G09G 2320/02; G09G 2300/0819

(57) ABSTRACT

An LCD panel and an LCD device are proposed. The LCD panel includes display pixels, a data line, a scan line, and thin-film transistors. The display pixels include a first display pixel and a second display pixel. The liquid crystal display panel displays black images through the second display pixel while displaying signal images through the first display pixel. The FPR liquid crystal display panel and the liquid crystal display device for 3D display in the present invention prevent from crosstalk between the left-eye signal image and the right-eye signal image by inputting a black image signal to partial pixels.

### BACKGROUND OF THE INVENTION

1. Field of the Invention

The present invention relates to a liquid crystal display field, more particularly, to a Film-type Patterned Retarder (FPR) liquid crystal display panel and a liquid crystal display device for 3D display.

2. Description of the Prior Art

With continuous development for display technology, 3D display technology is maturing. 3D image devices, such as 3D TV, 3D projection, 3D camera, etc, are invented. Compared with 2D display technique, 3D display technique displays images more lifelike to have a better vision effect and becomes mainstream development for display devices in the future.

Film-type Patterned Retarder (FPR) display is one of imaging mode for 3D liquid crystal display in the prior art. As FIG. 1 shows, FIG. 1 is an operating principle diagram of a conventional FPR 3D display system. The FPR 3D display system comprises a liquid crystal display panel 11, a patterned retarder film 12 and a pair of patterned retarder glasses 13. The liquid crystal display panel 11 comprises pixels 16 showing left-eye signals, pixels 17 showing right-eye signals and a black matrix 18 therebetween. The FPR 3D display system separates a 3D image into a left-eye image 14 and a right-eye image 15 by the patterned retarder film 12 adhering onto the liquid crystal display panel 11. The left-eye image 14 and the right-eye image 15 are viewed by the user's left eye and right eye respectively via the patterned retarder glasses 13. Finally, user's brain synthesizes 3D image according to two sets of the images from the left and right eye.

The operating principle of the liquid crystal display panel 11 is illustrated in FIGS. 2A and 2B. FIG. 2A is a structure diagram of a conventional liquid crystal display panel, and FIG. 2B is a timing diagram of driving signals applied in the conventional liquid crystal display panel. When the liquid crystal display panel is operating, a thin-film transistor (TFT) 22 turns on in response to a scan signal 21, and pixels in each row are charged by data signals 23. Therefore, each pixel 24 incorporating with backlight and a patterned retarder film shows various grey levels according to rotation of the liquid crystal. The scan signal 21 is triggered by a CKV clock signal 25. Each scan signal 21 in FIG. 2A controls one row of pixels 24 to turn on or off. The data signal 23 is triggered by a TP (triggering pulse) signal 26. Each data signal 23 in FIG. 2A controls grey level displayed by one column of pixels 24, whereas the display pixels 24 in odd rows display left-eye signal images (the data signal 23 is left-eye image signal 231), the display pixels 24 in even rows display right-eye signal images (the data signal 23 is right-eye image signal 232). The left-eye and right-eye signal images are respectively received by user's left eye and right eye via the patterned retarder film 12 and the patterned retarder glasses 13. Finally, the brain synthesizes 3D image according to the received left-eye and right-eye signal images. Since two display pixels in adjacent rows of the liquid crystal display panel 11 is very close as FIG. 1 shows, it occurs crosstalk between the left-eye signal image and the right-eye signal image when viewing at a larger viewing angle, which means the right-eye images is viewed by the left eye, to influence a display effect of the liquid crystal display panel.

### SUMMARY OF THE INVENTION

An object of the present invention is to provide an FPR liquid crystal display panel and a liquid crystal display device for 3D display for solving a serious technical problem of crosstalk between left-eye signal images and right-eye images of a FPR liquid crystal display panel and a liquid crystal display device for 3D display in the prior art.

According to the present invention, a Film-type Patterned Retarder (FPR) liquid crystal display panel for 3D display comprises: a plurality of display pixels; a data line for inputting data signals to the display pixels; a scan line for inputting scan signals to the display pixels; and a thin-film transistor (TFT) for charging liquid crystal in the display pixels by the data signals according to the scan signals. The display pixels comprise a first display pixel and a second display pixel set up alternatively in row. The liquid crystal display panel displays black images through the second display pixel while displaying signal images through the first display pixel. The liquid crystal display panel displays black images through the first display pixel while displaying signal images through the second display pixel.

In one aspect of the present invention, the liquid crystal display panel stops inputting the data signal to the second display pixel through the scan signals while displaying signal images through the first display pixel. The liquid crystal display panel stops inputting the data signals to the first display pixel through the scan signals while displaying signal images through the second display pixel.

In another aspect of the present invention, the liquid crystal display panel alternatively inputs a left-eye image signal and a right-eye image signal to the first display pixel in the same frame while displaying signal images through the first display pixel. The liquid crystal display panel alternatively inputs a left-eye image signal and a right-eye image signal to the second display pixel in the same frame while displaying signal images through the second display pixel.

In another aspect of the present invention, the liquid crystal display panel inputs a left-eye image signal to the first display pixel in odd frames and inputs a right-eye image signal to the first display pixel in even frames while displaying signal images through the first display pixel. The liquid crystal display panel inputs a left-eye image signal to the first display pixel in even frames and inputs a right-eye image signal to the first display pixel in odd frames while displaying signal images through the first display pixel.

In another aspect of the present invention, the liquid crystal display panel inputs a left-eye image signal to the second display pixel in odd frames and inputs a right-eye image signal to the second display pixel in even frames while displaying signal images through the second display pixel. The liquid crystal display panel inputs a left-eye image signal to the second display pixel in even frames and inputs a right-eye image signal to the second display pixel in odd frames while displaying signal images through the second display pixel.

In another aspect of the present invention, the liquid crystal display panel displays left-eye images through the first display pixel and stops inputting the data signals to the second display pixel through the scan signals in odd frames, and the liquid crystal display panel displays right-eye images through the second display pixel and stops inputting the data signals to the first display pixel through the scan signals in even frames.

In another aspect of the present invention, the liquid crystal display panel displays black images through the second display pixel while displaying signal images through the first display pixel. The liquid crystal display panel displays black images through the first display pixel while displaying signal images through the second display pixel.

In another aspect of the present invention, the liquid crystal display panel alternatively inputs left-eye image signals and right-eye image signals to the first display pixel in the same frame while displaying signal images through the first display pixel. The liquid crystal display panel alternatively inputs left-eye image signals and right-eye image signals to the second display pixel in the same frame while displaying signal images through the second display pixel.

In another aspect of the present invention, the liquid crystal display panel inputs a left-eye image signal to the first display pixel in odd frames and inputs a right-eye image signal to the first display pixel in even frames while displaying signal images through the first display pixel. The liquid crystal display panel inputs a left-eye image signal to the first display pixel in even frames and inputs a right-eye image signal to the first display pixel in odd frames while displaying signal images through the first display pixel.

In still another aspect of the present invention, the liquid crystal display panel inputs a left-eye image signal to the second display pixel in odd frames and inputs a right-eye image signal to the second display pixel in even frames while displaying signal images through the second display pixel. The liquid crystal display panel inputs a left-eye image signal to the second display pixel in even frames and inputs a right-eye image signal to the second display pixel in odd frames while displaying signal images through the second display pixel.

In yet another aspect of the present invention, the liquid crystal display panel displays black images through the second display pixel while displaying left-eye signal images through the first display pixel in odd frames, and the liquid crystal display panel displays black images through the first display pixel while displaying right-eye signal images through the second display pixel in even frames.

According to the present invention, a liquid crystal display device comprises a Film-type Patterned Retarder (FPR) liquid crystal display panel for 3D display. The FPR liquid crystal display panel comprises: a plurality of display pixels; a data line for inputting data signals to the display pixels; a scan line for inputting scan signals to the display pixels; and a thin-film transistor (TFT) for charging liquid crystal in the display pixels by the data signals according to the scan signals. The display pixels comprise a first display pixel and a second display pixel set up alternatively in row. The liquid crystal display panel displays black images through the second display pixel while displaying signal images through the first display pixel. The liquid crystal display panel displays black images through the first display pixel while displaying signal images through the second display pixel.

In one aspect of the present invention, the liquid crystal display panel stops inputting the data signal to the second display pixel through the scan signals while displaying signal images through the first display pixel. The liquid crystal display panel stops inputting the data signals to the first display pixel through the scan signals while displaying signal images through the second display pixel.

In another aspect of the present invention, the liquid crystal display panel alternatively inputs a left-eye image signal and a right-eye image signal to the first display pixel in the same frame while displaying signal images through the first display pixel. The liquid crystal display panel alternatively inputs a left-eye image signal and a right-eye image signal to the second display pixel in the same frame while displaying signal images through the second display pixel.

In another aspect of the present invention, the liquid crystal display panel inputs a left-eye image signal to the first display pixel in odd frames and inputs a right-eye image signal to the first display pixel in even frames while displaying signal images through the first display pixel. The liquid crystal display panel inputs a left-eye image signal to the first display pixel in even frames and inputs a right-eye image signal to the first display pixel in odd frames while displaying signal images through the first display pixel.

In another aspect of the present invention, the liquid crystal display panel displays left-eye images through the first display pixel and stops inputting the data signals to the second display pixel through the scan signals in odd frames, and the liquid crystal display panel displays right-eye images through the second display pixel and stops inputting the data signals to the first display pixel through the scan signals in even frames.

In another aspect of the present invention, the liquid crystal display panel displays black images through the second display pixel while displaying signal images through the first display pixel. The liquid crystal display panel displays black images through the first display pixel while displaying signal images through the second display pixel.

In another aspect of the present invention, the liquid crystal display panel alternatively inputs left-eye image signals and right-eye image signals to the first display pixel in the same frame while displaying signal images through the first display pixel. The liquid crystal display panel alternatively inputs left-eye image signals and right-eye image signals to the second display pixel in the same frame while displaying signal images through the second display pixel.

In still another aspect of the present invention, the liquid crystal display panel inputs a left-eye image signal to the first display pixel in odd frames and inputs a right-eye image signal to the first display pixel in even frames while displaying signal images through the first display pixel. The liquid crystal display panel inputs a left-eye image signal to the first display pixel in even frames and inputs a right-eye image signal to the first display pixel in odd frames while displaying signal images through the first display pixel.

In yet another aspect of the present invention, the liquid crystal display panel displays black images through the second display pixel while displaying left-eye signal images through the first display pixel in odd frames, and the liquid crystal display panel displays black images through the first display pixel while displaying right-eye signal images through the second display pixel in even frames.

Compared with the FPR liquid crystal display panel and the liquid crystal display device for is 3D display in the prior art, the FPR liquid crystal display panel and the liquid crystal display device for 3D display in the present invention prevent from crosstalk between the left-eye signal image and the right-eye signal image by inputting a black image signal to partial pixels so that it solves a serious technical problem of mutual crosstalk between left-eye signal images and right-eye images of the FPR liquid crystal display panel and the liquid crystal display device for 3D display in the prior art.

These and other features, aspects and advantages of the present disclosure will become understood with reference to the following description, appended claims and accompanying figures.

### BRIEF DESCRIPTION OF THE DRAWINGS

FIG. 1 illustrates an operating principle diagram of a conventional FPR 3D display system.

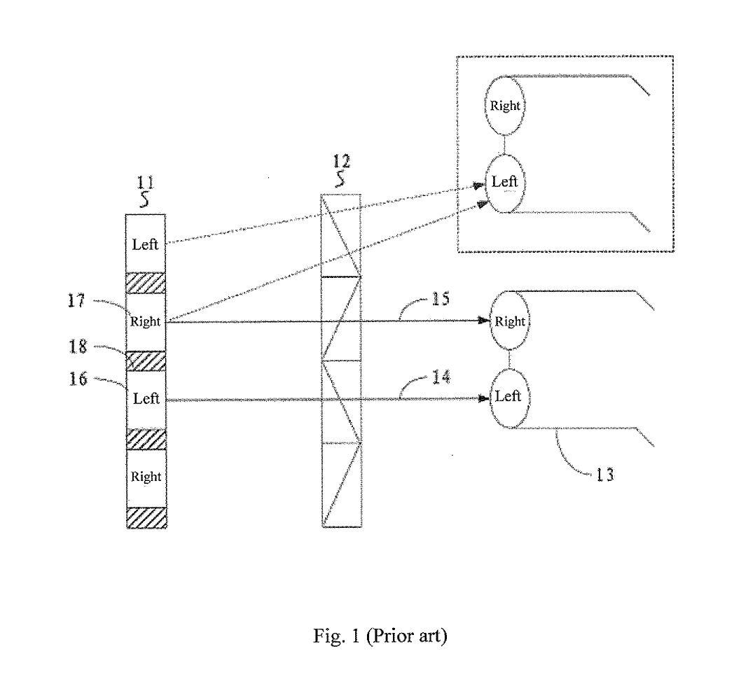

FIG. 2A is a structure diagram of a conventional liquid crystal display panel.

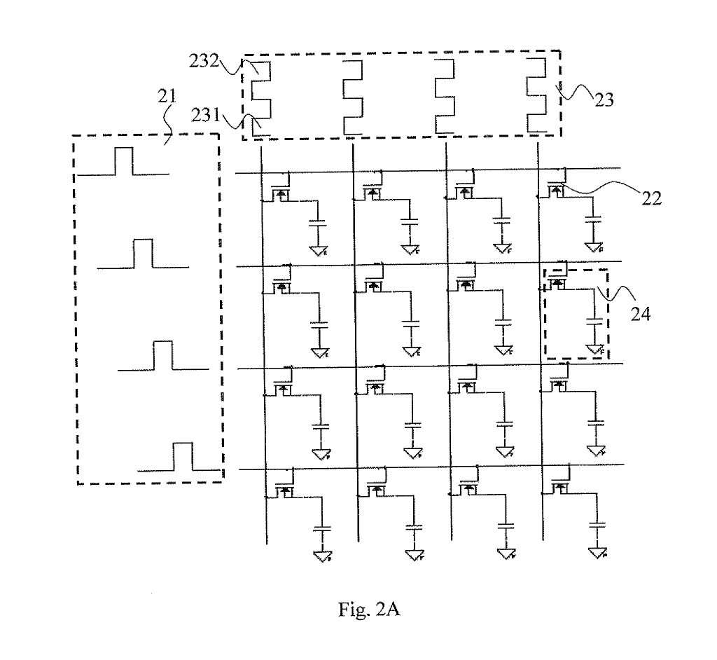

FIG. 2B is a timing diagram of driving signals applied in the conventional liquid crystal display panel.

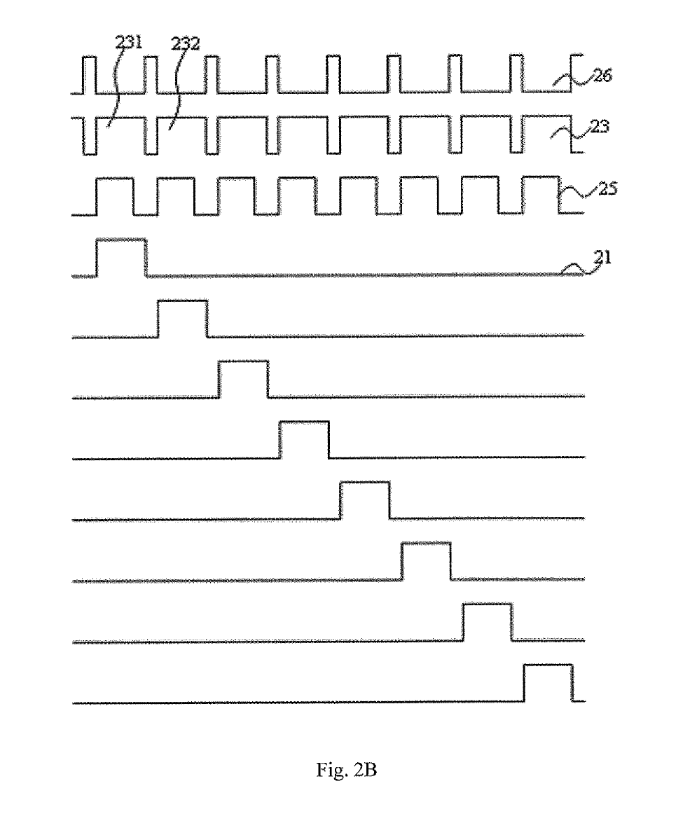

FIG. 3A is a structure diagram of a liquid crystal display panel according to a preferred embodiment of the present invention.

FIG. 3B is a timing diagram of driving signals applied on a liquid crystal display panel according to a first preferred embodiment of the present invention.

FIG. 4A is a timing diagram of driving signals when showing odd frames according to a second preferred embodiment of the present invention.

FIG. 4B is a timing diagram of driving signals when showing even frames according to the second preferred embodiment of the present invention.

FIG. 5 is a timing diagram of driving signals applied on the liquid crystal display panel according to a third preferred embodiment of the present invention.

FIG. 6A is a timing diagram of driving signals when showing odd frames according to a fourth preferred embodiment of the present invention.

FIG. 6B is a timing diagram of driving signals when showing even frames according to the fourth preferred embodiment of the present invention.

### DETAILED DESCRIPTION OF THE PREFERRED EMBODIMENTS

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

Please note, the same components are labeled by the same number.

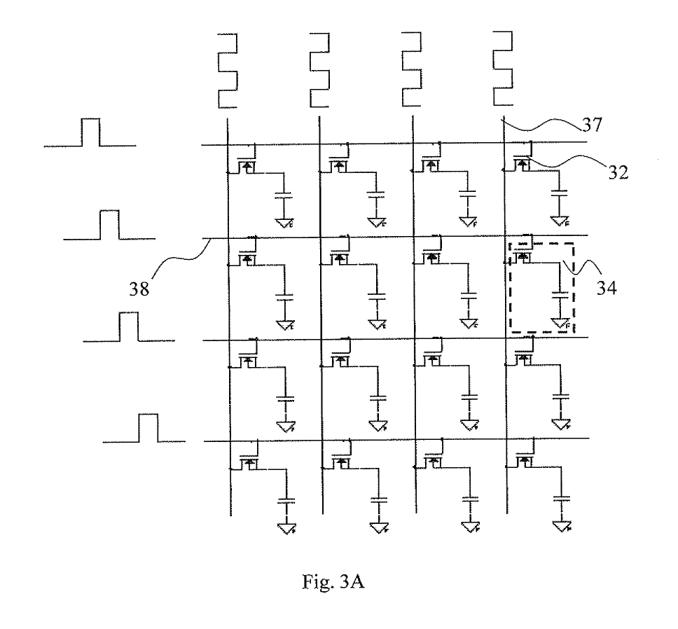

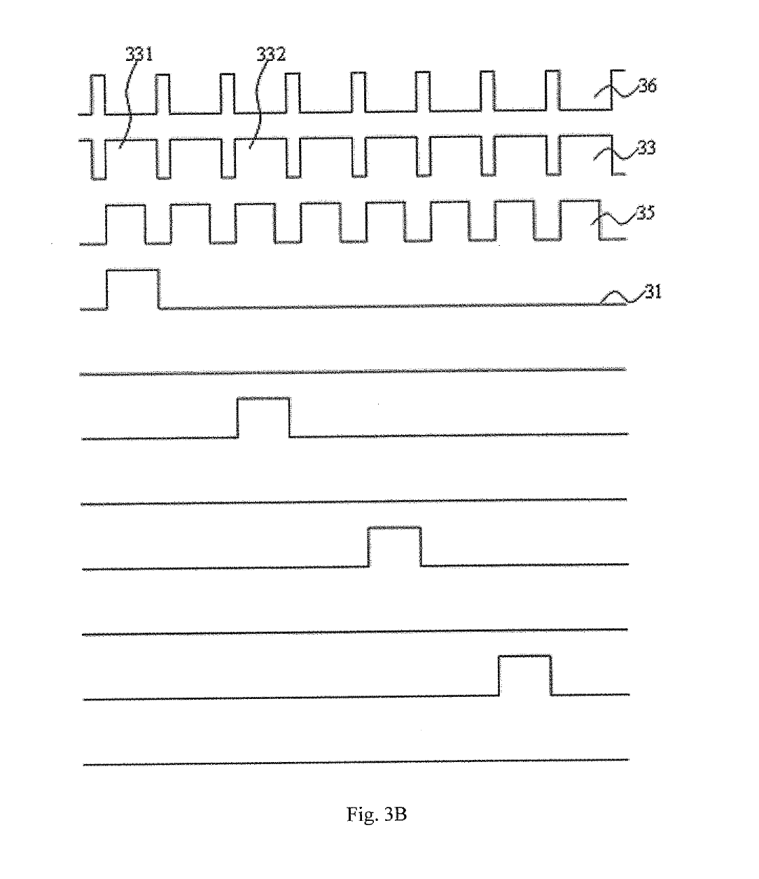

Please refer to FIG. 3A, FIG. 3A is a structure diagram of a liquid crystal display panel according to a preferred embodiment of the present invention. The FPR liquid crystal display panel for 3D display comprises a plurality of display pixels 34, data lines 37, scan lines 38 and TFTs 32. The data lines 37 are used for inputting data signals to the display pixels 34, the scan lines 38 are used for inputting scan signals to the display pixels 34, and the TFTs 32 are used for charging liquid crystal in display pixels by the data signal in response to the scan signal. The display pixels 34 comprise first display pixels and second display pixels. The first display pixels and the second display pixels are arranged alternatively in row (for instance, the first display pixels are the display pixels 34 in odd rows, and the second display pixels are the display pixels 34 in even rows, or the first display pixels are the display pixels 34 in even rows, and the second display pixels are the display pixels 34 in odd rows). The first and second display pixels are fed with data signal upon receiving scan signals. The second display pixels display black images while the first display pixels display signal images, or the first display pixels display black images while the second display pixels display signal images. In hence, the display pixels displaying signal images are separated by the display pixels displaying black images, thereby increasing intervals between display pixels displaying display signal images. Therefore, it effectively prevents from crosstalk between signal images and assures a display effect of a liquid crystal display panel.

The following illustrates a driving process of the liquid crystal display panel according to the present invention in FIG. 3B to 6B.

Please refer to FIG. 3B, FIG. 3B is a timing diagram of driving signals applied on a liquid crystal display panel according to a first preferred embodiment of the present invention. In the preferred embodiment, the liquid crystal display panel stops inputting the data signals 33 to the second display pixels through the scan signals 31 and inputs the left-eye image signal 331 and the right-eye image signal 332 alternatively to the first display pixels in the same frame when displaying signal images through the first display pixels. The liquid crystal display panel stops inputting the data signals 33 to the first display pixels through the scan signals 31 and inputs the left-eye image signal 331 and the right-eye image signal 332 alternatively to the second display pixels in the same frame when displaying signal images through the second display pixels.

As FIG. 3 shows, the scan signals 31 are triggered by the CKV signal 35, each of the scan signals 31 controls one row of display pixels to turn on or off, the data signals 33 are triggered by the TP signal 36, each of the data signals 33 controls one column of signal images of display pixels. When the liquid crystal display panel of the preferred embodiment works, the scan signals 31 turn correspondent display pixels on, and in the same frame, the scan signals 31 turn all display pixels in odd rows on in order and all display pixels in even rows off while inputting the left-eye image signal 331 and the right-eye image signal 332 alternatively. Therefore, the display pixels in the first row of the liquid crystal display panel display the left-eye image signal 331, those in the second row display none, those in the third row display the right-eye image signal 332, those in the fourth row display none, . . . those in the (4n+1) row display the left-eye image signal 331, those in the (4n+2) row display none, those in the (4n+3) row display the right-eye image signal 332, and those in the (4n+4) row display none. In hence, it makes the display pixels in the (4n+1) row displaying the left-eye image signal 331 and the display pixels in the (4n+3) row displaying the right-eye image signal 332 being separated by the display pixels displaying none, which prevents from crosstalk between the left-eye image signal 331 and the right-eye image signal 332, and it improves the display effect of the liquid crystal display panel thus.

In the preferred embodiment, it also allows that display pixels in the (4n+1) row and in the (4n+3) row display none, display pixels in the (4n+2) row and in the (4n+4) row respectively display the left-eye image signal 331 and the right-eye image signal 332. It is the same way to improve the display quality of the liquid crystal display panel.

The FPR liquid crystal display panel for 3D display prevents from crosstalk between a left-eye image signal and a right-eye image signal by inputting black image signals to partial pixels.

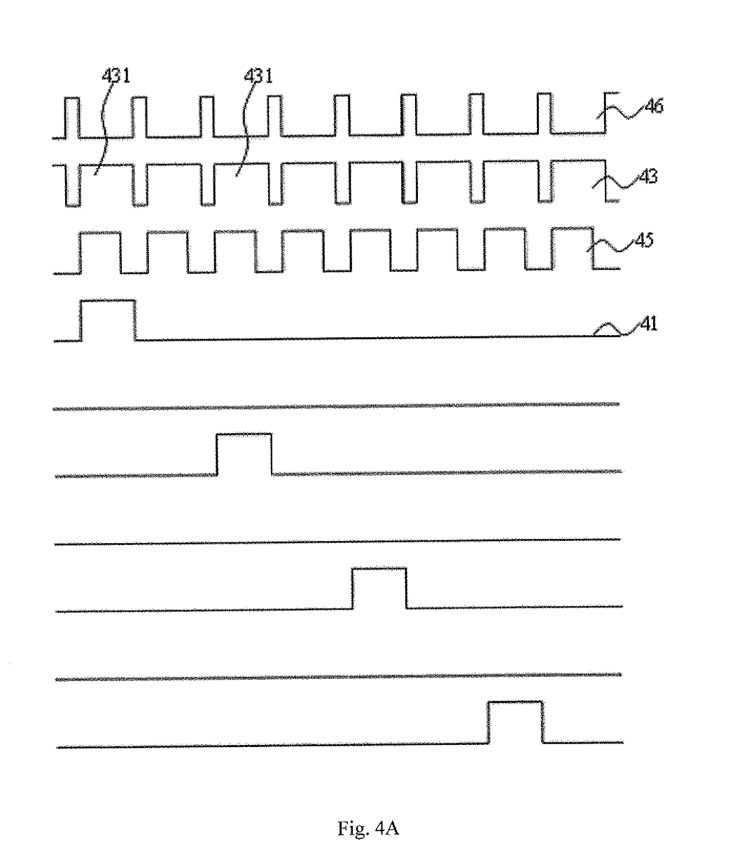

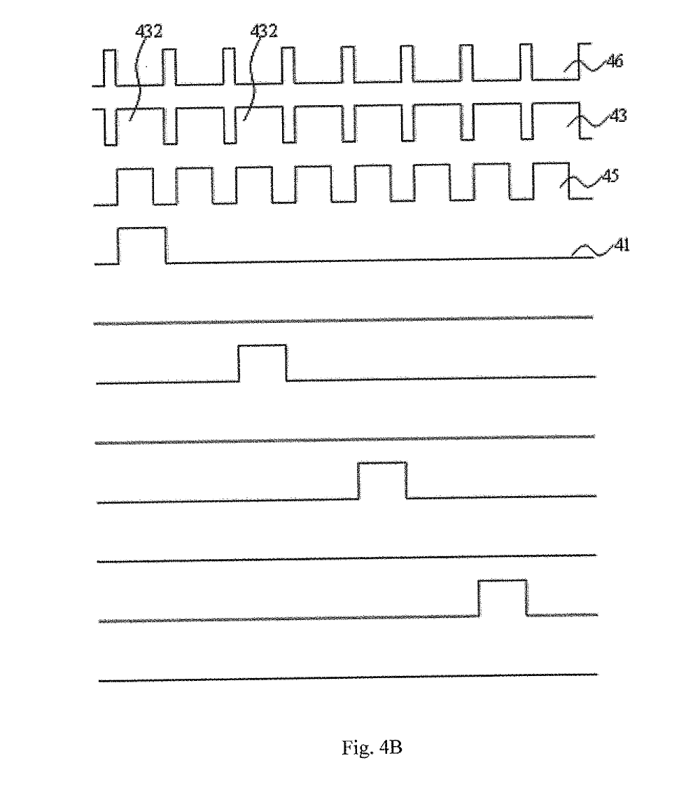

Please refer to FIGS. 4A and 4B, FIG. 4A is a timing diagram of driving signals in odd frames according to a second preferred embodiment of the present invention, and FIG. 4B is a timing diagram of driving signals in even frames according to the second preferred embodiment of the present invention. In the preferred embodiment, the liquid crystal display panel stops inputting the data signals 43 to the second display pixels through the scan signals 41 and inputs the left-eye image signal 431 to the first display pixels in odd frames and the right-eye image signal 432 to the first display pixels in even frames, or the liquid crystal display panel inputs the right-eye image signal 432 to the first display pixels in odd frames and the left-eye image signal 431 to the first display pixels in even frames when displaying signal images through the first display pixels.

The liquid crystal display panel stops inputting the data signals 43 to the first display pixels through the scan signals 41 and inputs the left-eye image signal 431 to the second display pixels in odd frames and the right-eye image signal 432 to the second display pixels in even frames, or the liquid crystal display panel inputs the right-eye image signal 432 to the second display pixels in even frames and the left-eye image signal 431 to the second display pixels in odd frames when displaying signal images through the second display pixels.

As FIGS. 4A and 4B show, the scan signals 41 are triggered by the CKV signal 45, each of the scan signals 41 controls one row of display pixels to turn on or off, the data signals 43 are triggered by the TP signal 46, each of the data signals 43 controls signal images in one column of display pixels. When the liquid crystal display panel of the preferred embodiment works, the scan signals 41 turn correspondent display pixels on, and in odd frames (as shown in FIG. 4A), the scan signals 41 turn all display pixels in odd rows on in order and all display pixels in even rows off while inputting the left-eye image signal 431. In even frames (as shown in FIG. 4B), the scan signals 41 turn all display pixels in odd rows on in order and all display pixels in even rows off while inputting the right-eye image signal 432. Therefore, in the end, the odd frames of the liquid crystal display panel only display left-eye images, the even frames of the liquid crystal display panel only display right-eye images, and image signals in each frame are separated by the display pixels displaying none. It prevents from crosstalk between image signals because left-eye images and right-eye images are displayed by different frames.

Besides that, it also allows that it inputs the right-eye image signal 432 to the second display pixels in even frames and stops inputting data signals to the first display pixels if it inputs the left-eye image signal 431 to the first display pixels in odd frames and stops inputting data signals to the second display pixels. Therefore, it is also under protection of the preferred embodiment that display of the left-eye and the right-eye images by separating frames and dividing display pixels.

The FPR liquid crystal display panel for 3D display of the preferred embodiment prevents from crosstalk between the left-eye and right-eye image signals by displaying separated frames.

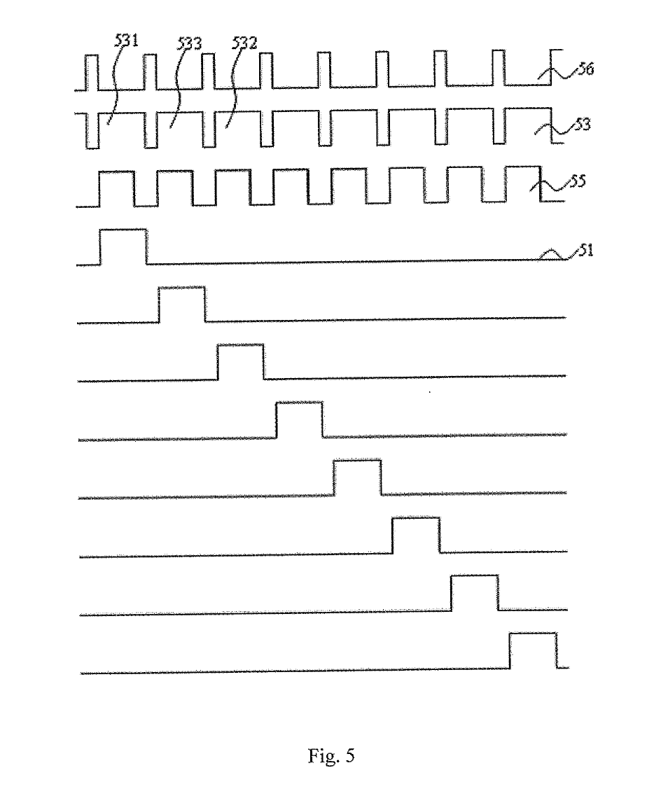

Please refer to FIG. 5, FIG. 5 is a timing diagram of driving signals applied on the liquid crystal display panel according to a third preferred embodiment of the present invention. In the preferred embodiment, the liquid crystal display panel displays black images through the second display pixels and alternatively inputs the left-eye image signal 531 and the right-eye image signal 532 to the first display pixels in the same frame when displaying signal images through the first display pixels. The liquid crystal display panel displays black images through the first display pixels and alternatively inputs the left-eye image signal 531 and the right-eye image signal 532 to the second display pixels in the same frame when displaying signal images through the second display pixels. As FIG. 5 shows, the scan signals 51 are triggered by the CKV signal 55, each of the scan signals 51 controls one row of display pixels to turn on or off, the data signals 53 are triggered by the TP signal 56, each of the data signals 53 controls signal images in one column of display pixels. When the liquid crystal display panel of the preferred embodiment works, the scan signals 51 turn correspondent display pixels on, and in the same frame, the scan signals 51 turn all display pixels in order while inputting the left-eye image signal 531, the black image signal 533, the right-eye image signal 532 and the black image signal 533 alternatively, which means it inputs the left-eye signal 531 and the right-eye signal 532 alternatively to the first display pixels (i.e. the display pixels in odd rows) while inputting only the black image signal 533 to the second display pixels (i.e. the display pixels in even rows). Therefore, in the end, the display pixels in the first row of the liquid crystal display panel display the left-eye image signal 531, those in the second row display the black image signal 533, those in the third row display the right-eye image signal 532, those in the fourth row display the black image signal 533, in the (4n+1) row display the left-eye image signal 531, those in the (4n+2) row display the black image signal 533, those in the (4n+3) row display the right-eye image signal 532, and those in the (4n+4) row display the black image signal 533. In hence, it makes the display pixels in the (4n+1) row displaying the left-eye image signal 531 and the display pixels in the (4n+3) row displaying the right-eye image signal 532 being separated by the display pixels displaying none, which prevents from crosstalk between the left-eye image signal 531 and the right-eye image signal 532, and it improves the display effect of the liquid crystal display panel thus.

In the preferred embodiment, it also allows that display pixels in the (4n+1) row and in the (4n+3) row display the black image signal 533, display pixels in the (4n+2) row and in the (4n+4) row respectively display the left-eye image signal 531 and the right-eye image signal 532. It is the same way to improve the display quality of the liquid crystal display panel.

The FPR liquid crystal display panel for 3D display of the embodiment prevents from crosstalk between a left-eye image signal and a right-eye image signal by inputting black image signals to partial pixels.

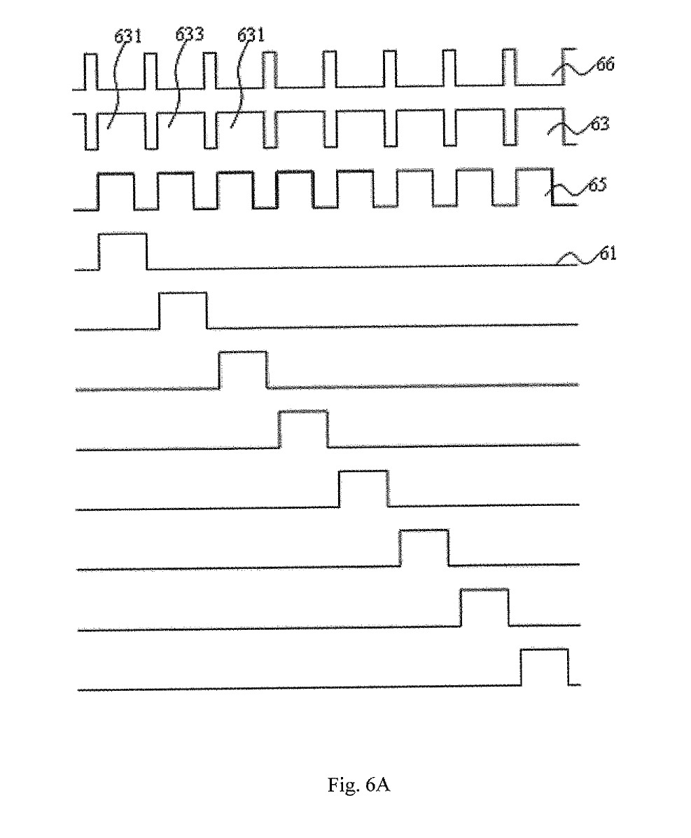

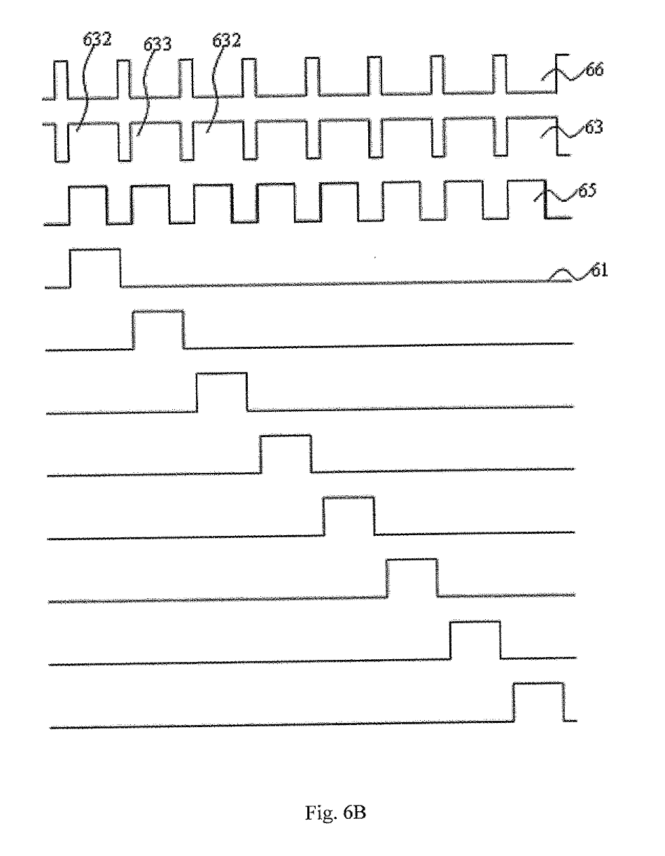

Please refer to FIGS. 6A and 6B, FIG. 6A is a timing diagram of driving signals when showing odd frames according to a fourth preferred embodiment of the present invention, and FIG. 6B is a timing diagram of driving signals when showing even frames according to the fourth preferred embodiment of the present invention. In the preferred embodiment, the liquid crystal display panel displays black images through the second display pixels, inputs the left-eye image signal 631 to the first display pixels in odd frames and the right-eye image signal 632 to the first display pixels in even frames, or the liquid crystal display panel inputs the right-eye image signal 632 to the first display pixels in odd frames and the left-eye image signal 631 to the first display pixels in even frames when displaying signal images through the first display pixels.

The liquid crystal display panel displays black images through the second display pixels, inputs the left-eye image signal 631 to the second display pixels in odd frames and the right-eye image signal 632 to the second display pixels in even frames, or the liquid crystal display panel inputs the left-eye image signal 631 to the second display pixels in even frames and the right-eye image signal 632 to the second display pixels in odd frames when displaying signal images through the second display pixel. As FIGS. 6A and 6B show, the scan signals 61 are triggered by the CKV signal 65, each of the scan signals 61 controls one row of display pixels to turn on or off, the data signals 63 are triggered by the TP signal 66, each of the data signals 63 controls signal images in one column of display pixels. When the liquid crystal display panel of the preferred embodiment works, the scan signals 61 turn correspondent display pixels on, and in odd frames (as shown in FIG. 6A), the scan signals 61 turn all display pixels on in order while inputting the left-eye image signal 631 and the black image signal 633 alternatively to the turn-on display pixels. In even frames (as shown in FIG. 6B), the scan signals 61 turn all display pixels on in order while inputting the right-eye image signal 632 and the black image signal 633 alternatively to the turn-on display pixels, which means it inputs the right-eye image signal 632 to the first display pixels (the display pixels in odd rows) and only inputs the black image signal 633 to the second display pixels (the display pixels in even rows). Therefore, in the end, the odd frames of the liquid crystal display panel only display left-eye images, the even frames of the liquid crystal display panel only display right-eye images, and image signals in each frame are separated by the display pixels displaying black images. It prevents from crosstalk between image signals because left-eye images and right-eye images are displayed by different frames.

Besides that, it also allows that it inputs the left-eye image signal 632 to the second display pixels and inputs the black image signal 633 to the first display pixels in even frames if it inputs the left-eye image signal 631 to the first display pixels and inputs the black image signal 633 to the second display pixels in odd frames. Therefore, it is also under protection of the preferred embodiment that display of the left-eye and the right-eye images by separating frames and dividing display pixels.

The FPR liquid crystal display panel for 3D display of the preferred embodiment based on the third preferred embodiment prevents from crosstalk between the left-eye and right-eye image signals by separating frames.

The present invention further provides a liquid crystal display device using the above-mentioned liquid crystal display panel. The operating principle of the liquid crystal display panel is identical to that of the above-mentioned liquid crystal display panel of the preferred embodiment, and the detail is demonstrated in the relative description of the above-mentioned liquid crystal display panel of the preferred embodiment.

In sum, the FPR liquid crystal display panel and the liquid crystal display device for 3D display in the present invention prevent from crosstalk between the left-eye signal image and the right-eye signal image by inputting a black image signal to partial pixels so that it solves a serious technical problem of mutual crosstalk between left-eye signal images and right-eye images of the liquid crystal display panel and the FPR liquid crystal display device for 3D display in the prior art.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A Film-type Patterned Retarder (FPR) liquid crystal display panel for 3D display comprising:
a plurality of display pixels;
a data line for inputting data signals to the display pixels;
a scan line for inputting scan signals to the display pixels; and
a thin-film transistor (TFT) for charging liquid crystal in the display pixels by the data signals according to the scan signals;
wherein the display pixels comprise a first display pixel and a second display pixel set up alternatively in row,
the liquid crystal display panel displays black images through the second display pixel while displaying signal images through the first display pixel; and
the liquid crystal display panel displays black images through the first display pixel while displaying signal images through the second display pixel.

2. The FPR liquid crystal display panel for 3D display of claim 1, wherein
the liquid crystal display panel stops inputting the data signal to the second display pixel through the scan signals while displaying signal images through the first display pixel; and
the liquid crystal display panel stops inputting the data signals to the first display pixel through the scan signals while displaying signal images through the second display pixel.

3. The FPR liquid crystal display panel for 3D display of claim 2, wherein
the liquid crystal display panel alternatively inputs a left-eye image signal and a right-eye image signal to the first display pixel in the same frame while displaying signal images through the first display pixel; and
the liquid crystal display panel alternatively inputs a left-eye image signal and a right-eye image signal to the second display pixel in the same frame while displaying signal images through the second display pixel.

4. The FPR liquid crystal display panel for 3D display of claim 2, wherein
the liquid crystal display panel inputs a left-eye image signal to the first display pixel in odd frames and inputs a right-eye image signal to the first display pixel in even frames while displaying signal images through the first display pixel; and
the liquid crystal display panel inputs a left-eye image signal to the first display pixel in even frames and inputs a right-eye image signal to the first display pixel in odd frames while displaying signal images through the first display pixel.

5. The FPR liquid crystal display panel for 3D display of claim 2, wherein
the liquid crystal display panel inputs a left-eye image signal to the second display pixel in odd frames and inputs a right-eye image signal to the second display pixel in even frames while displaying signal images through the second display pixel; and
the liquid crystal display panel inputs a left-eye image signal to the second display pixel in even frames and inputs a right-eye image signal to the second display pixel in odd frames while displaying signal images through the second display pixel.

6. The FPR liquid crystal display panel for 3D display of claim 2, wherein
the liquid crystal display panel displays left-eye images through the first display pixel and stops inputting the data signals to the second display pixel through the scan signals in odd frames, and the liquid crystal display panel displays right-eye images through the second display pixel and stops inputting the data signals to the first display pixel through the scan signals in even frames.

7. The FPR liquid crystal display panel for 3D display of claim 1, wherein the liquid crystal display panel displays black images through the second display pixel while displaying signal images through the first display pixel; and
the liquid crystal display panel displays black images through the first display pixel while displaying signal images through the second display pixel.

8. The FPR liquid crystal display panel for 3D display of claim 7, wherein the liquid crystal display panel alternatively inputs left-eye image signals and right-eye image signals to the first display pixel in the same frame while displaying signal images through the first display pixel; and
the liquid crystal display panel alternatively inputs left-eye image signals and right-eye image signals to the second display pixel in the same frame while displaying signal images through the second display pixel.

9. The FPR liquid crystal display panel for 3D display of claim 7, wherein
the liquid crystal display panel inputs a left-eye image signal to the first display pixel in odd frames and inputs a right-eye image signal to the first display pixel in even frames while displaying signal images through the first display pixel; and
the liquid crystal display panel inputs a left-eye image signal to the first display pixel in even frames and inputs a right-eye image signal to the first display pixel in odd frames while displaying signal images through the first display pixel.

10. The FPR liquid crystal display panel for 3D display of claim 7, wherein
the liquid crystal display panel inputs a left-eye image signal to the second display pixel in odd frames and inputs a right-eye image signal to the second display pixel in even frames while displaying signal images through the second display pixel; and
the liquid crystal display panel inputs a left-eye image signal to the second display pixel in even frames and inputs a right-eye image signal to the second display pixel in odd frames while displaying signal images through the second display pixel.

11. The FPR liquid crystal display panel for 3D display of claim 7, wherein the liquid crystal display panel displays black images through the second display pixel while displaying left-eye signal images through the first display pixel in odd frames, and the liquid crystal display panel displays black images through the first display pixel while displaying right-eye signal images through the second display pixel in even frames.

12. A liquid crystal display device comprising a Film-type Patterned Retarder (FPR) liquid crystal display panel for 3D display, the FPR liquid crystal display panel comprising:
a plurality of display pixels;
a data line for inputting data signals to the display pixels;
a scan line for inputting scan signals to the display pixels; and
a thin-film transistor (TFT) for charging liquid crystal in the display pixels by the data signals according to the scan signals;
wherein the display pixels comprise a first display pixel and a second display pixel set up alternatively in row,
the liquid crystal display panel displays black images through the second display pixel while displaying signal images through the first display pixel; and
the liquid crystal display panel displays black images through the first display pixel while displaying signal images through the second display pixel.

13. The liquid crystal display device of claim 12, wherein
the liquid crystal display panel stops inputting the data signal to the second display pixel through the scan signals while displaying signal images through the first display pixel; and
the liquid crystal display panel stops inputting the data signals to the first display pixel through the scan signals while displaying signal images through the second display pixel.

14. The liquid crystal display device of claim 13, wherein
the liquid crystal display panel alternatively inputs a left-eye image signal and a right-eye image signal to the first display pixel in the same frame while displaying signal images through the first display pixel; and
the liquid crystal display panel alternatively inputs a left-eye image signal and a right-eye image signal to the second display pixel in the same frame while displaying signal images through the second display pixel.

15. The FPR liquid crystal display panel for 3D display of claim 13, wherein
the liquid crystal display panel inputs a left-eye image signal to the first display pixel in odd frames and inputs a right-eye image signal to the first display pixel in even frames while displaying signal images through the first display pixel; and
the liquid crystal display panel inputs a left-eye image signal to the first display pixel in even frames and inputs a right-eye image signal to the first display pixel in odd frames while displaying signal images through the first display pixel.

16. The liquid crystal display device of claim 13, wherein
the liquid crystal display panel displays left-eye images through the first display pixel and stops inputting the data signals to the second display pixel through the scan signals in odd frames, and the liquid crystal display panel displays right-eye images through the second display pixel and stops inputting the data signals to the first display pixel through the scan signals in even frames.

17. The liquid crystal display device of claim 12, wherein the liquid crystal display panel displays black images through the second display pixel while displaying signal images through the first display pixel; and
the liquid crystal display panel displays black images through the first display pixel while displaying signal images through the second display pixel.

18. The liquid crystal display device of claim 17, wherein the liquid crystal display panel alternatively inputs left-eye image signals and right-eye image signals to the first display pixel in the same frame while displaying signal images through the first display pixel; and
the liquid crystal display panel alternatively inputs left-eye image signals and right-eye image signals to the second display pixel in the same frame while displaying signal images through the second display pixel.

19. The liquid crystal display device of claim 17, wherein
the liquid crystal display panel inputs a left-eye image signal to the first display pixel in odd frames and inputs a right-eye image signal to the first display pixel in even frames while displaying signal images through the first display pixel; and
the liquid crystal display panel inputs a left-eye image signal to the first display pixel in even frames and inputs a right-eye image signal to the first display pixel in odd frames while displaying signal images through the first display pixel.

20. The liquid crystal display device of claim 17, wherein the liquid crystal display panel displays black images through the second display pixel while displaying left-eye signal images through the first display pixel in odd frames, and the liquid crystal display panel displays black images through the first display pixel while displaying right-eye signal images through the second display pixel in even frames.
